(19) United States
(12) Patent Application Publication
(10) Pub. No.: US 2025/0010297 A1
(43) Pub. Date: Jan. 9, 2025

(54) MICROFLUIDIC CHIP, AND LIQUID INJECTION METHOD THEREFOR AND USE THEREOF

(71) Applicant: JIANGSU LOGILET BIOTECH CO., LTD., Suzhou (CN)

(72) Inventors: Pei DU, Suzhou (CN); Yang SU, Suzhou (CN); Yan ZHANG, Suzhou (CN)

(21) Appl. No.: 18/710,955

(22) PCT Filed: Oct. 8, 2022
(86) PCT No.: PCT/CN2022/123905

§ 371 Date: May 16, 2024

(30) Foreign Application Priority Data
Nov. 19, 2021 (CN) 202111376549.7

(51) Int. Cl. B01L 3/00

(52) U.S. Cl. CPC B01L 3/50273; B01L 2200/0684; B01L 2200/0689; B01L 2200/16; B01L 2300/0645; B01L 2300/0672

(57) ABSTRACT

A microfluidic chip, wherein the microfluidic chip comprises a microfluidic chip substrate, a conductive cover and a liquid injection housing, wherein the liquid injection housing is provided with at least one liquid injection conduit and an oil intake conduit;
wherein the liquid injection housing comprises an oil injection cavity, a sample dosing cavity, and at least one liquid injection cavity;
a liquid injection column connected to a corresponding one of the at least one liquid injection conduit is arranged respectively in each of the at least one liquid injection cavity, and each of the at least one liquid injection conduit forms a liquid injection channel;
an oil injection column is arranged in the oil injection cavity and is connected to the oil intake conduit;
and surfaces of the oil injection cavity and the at least one liquid injection cavity are each correspondingly provided with a spike component.

### TECHNICAL FIELD

The present disclosure relates to the technical field of microfluidic chips, and relates to a microfluidic chip, a liquid injection method therefor and the use thereof.

### BACKGROUND ART

The microfluidic chip integrates basic operating units, which are configured for sample preparation, reaction, separation, test and the like in biological, chemical and medical analysis processes, into a chip with a micro-scale structure. The chip uses the principle of electrowetting technology, regulates solid-liquid surface energy by means of electric potential, and drives a liquid to move by virtue of the surface energy imbalance, so as to achieve precise control on micro-liquid.

During the liquid injection in the microfluidic chip, an operator typically needs to suck a certain amount of liquid sample by a pipette, align the pipette with a sample inlet to completely inject the liquid into a reaction cavity. However, the use of a pipette to inject a sample increases use costs, and has high requirements on the operator's operating accuracy.

CN 209406357 U discloses a microfluidic chip that facilitates liquid injection. The microfluidic chip comprises a substrate and a cover plate. The substrate is provided with a plurality of microfluidic channels, the substrate and the cover plate are bonded into a whole, and the microfluidic channels are located between the substrate and the cover plate. The microfluidic chip further comprises a connecting conduit, the cover plate is provided with at least one guide hole, the guide hole is in communication with the microfluidic channels, and the connecting conduit is detachably connected into the guide hole at one end.

CN 107988070 A discloses a microfluidic chip for micro-scale cell electroporation, a micro-scale cell electroporation sorter and applications thereof. The micro-scale cell electroporation sorter comprises an electroporation unit, a display screen, an outer box, a power supply unit, a micro control unit, and a primary sensor. The electroporation unit comprises the chip. The display screen is configured to send an instruction to the micro control unit and to receive and display information fed back by the micro control unit and the primary sensor; the micro control unit is configured to receive the instruction sent by the display screen and to control the electroporation unit and the power supply unit; the electroporation unit is configured to complete the process of cell transfection; and the primary sensor is configured to receive the information fed back by the electroporation unit and to send the same to the display screen and the micro control unit. The microfluidic chip for micro-scale cell electroporation comprises a sample inlet, a sample outlet, a negative pressure duct, a positive pressure duct, and a main channel. A 96-well plate is arranged behind the sample outlet. This invention can ensure consistent conditions in the main channel during the transfection process, ensure the transfection efficiency, ensure the cell quality by means of the 96-well plate, and facilitate later cell culture.

CN 108148752 A discloses an integrated drug screening and staining method based on a microfluidic chip. The microfluidic chip is configured to have a liquid path control layer as an upper layer, a gas path control layer as a lower layer, and a blank glass base plate at a bottom surface. The integrated drug screening and staining method based on a microfluidic chip sequentially comprises steps of: chip pre-processing; cell inoculation and culture; drug stimulation; and fluorescent staining. An inlet of each liquid path layer is separately controlled by a valve of a gas path layer, and culture of different types of cells, stimulation with different drugs and staining with different antibodies can be simultaneously implemented. This invention achieves drug screening and fluorescent staining on the microfluidic chip by utilizing microfluidic and micro-valve technology in the microfluidic chip, so that a completely new technology platform is provided for researches on cell culture, cell in-situ fluorescent staining and drug screening. This method is simple and convenient to operate, uses less cells and reagents, and has a high integration level and a wide range of applications.

In conventional technologies, fully manual reaction plates, such as 96-well plates and 384-well plates, or continuous microfluidic devices with syringe pumps, droplet microfluidics, etc. are used. However, the conventional technologies have great limitations in practical applications, and the fully manual operations are time-consuming and labor-intensive, have low precision and are likely to cause errors. The operations of the microfluidic devices and the droplet microfluidics rely strongly on syringe pumps and have higher costs. In addition, a sample intake method in the conventional technologies generally requires the use of a pipette or an external mechanical pump, which has high manufacturing costs, complex operating procedures, high repeatability, and limited use environment. Moreover, a liquid sample intake process comprises cumbersome steps and is likely to cause waste and misoperation. Therefore, there is an urgent need to design and develop a microfluidic chip and a method therefor in order to meet the needs of actual production and life.

### SUMMARY

According to a first aspect of embodiments of the present disclosure, a microfluidic chip is provided, wherein the microfluidic chip comprises a microfluidic chip substrate, a conductive cover and a liquid injection housing, which are sequentially stacked from bottom to top. The liquid injection housing is provided with at least one liquid injection conduit and an oil intake conduit. The liquid injection housing comprises an oil injection cavity, a sample dosing cavity, and at least one side-by-side arranged liquid injection cavity, the oil injection cavity, the sample dosing cavity and the at least one liquid injection cavity being configured to arrange an oil bubble cap, a sample dosing plug and at least one reagent bubble cap, respectively. A liquid injection column, which is connected to a corresponding one of the at least one liquid injection conduit, is arranged in each of the at least one liquid injection cavity, and each of the at least one liquid injection conduit forms a liquid injection channel. An oil injection column is arranged in the oil injection cavity, and the oil injection column is connected to the oil intake conduit. Surfaces of the oil injection cavity and the at least one liquid injection cavity are each correspondingly provided with a spike component.

According to a second aspect of the embodiments of the present disclosure, a liquid injection method for a microfluidic chip is provided. The liquid injection method comprises: during liquid injection, the liquid injection column continuously entering a corresponding reagent bubble cap to press a liquid in the reagent bubble cap, the reagent bubble cap forming a seal with the liquid injection column in the downward pressing process, piercing the reagent bubble cap by the respective spike component, the liquid in the reagent bubble cap flowing into the closed cavity of the microfluidic chip through the liquid injection channel, and regulating a voltage of the microelectrode array arranged on the base plate of the microfluidic chip substrate, such that the liquid flowing from the reagent bubble cap to the closed cavity reaches a designated position; and during oil injection, the oil injection column continuously entering the oil bubble cap to press a liquid in the oil bubble cap, the oil bubble cap forming a seal with the oil injection column in the downward pressing process, piercing the oil bubble cap by the respective spike component, the liquid in the oil bubble cap flowing into the closed cavity of the microfluidic chip through the oil intake hole, and regulating the voltage of the microelectrode array arranged on the base plate of the microfluidic chip substrate, such that the liquid flowing from the oil bubble cap to the closed cavity reaches a designated position.

According to a third aspect of the embodiments of the present disclosure, an oil injection method for a microfluidic chip is provided. The oil injection method comprises: during liquid injection, the liquid injection column continuously entering a corresponding reagent bubble cap to press a liquid in the reagent bubble cap, the reagent bubble cap forming a seal with the liquid injection column in the downward pressing process, piercing the reagent bubble cap by the respective spike component, the liquid in the reagent bubble cap flowing into the closed cavity of the microfluidic chip through the liquid injection channel, and regulating a voltage of the microelectrode array arranged on the base plate of the microfluidic chip substrate, such that the liquid flowing from the reagent bubble cap to the closed cavity reaches a designated position; and during oil injection, piercing the oil bubble cap by the respective spike component in the downward pressing process, and the liquid in the oil bubble cap flowing into the closed cavity of the microfluidic chip through the oil intake hole.

According to a fourth aspect of the present disclosure, a use for a microfluidic chip described in the first aspect is provided. The microfluidic chip is used in the field of digital microfluidic chips.

The microfluidic chip provided by the embodiments of the present disclosure pre-embeds reagents in advance and is integrated with a hole injection device, so that manual liquid injection and oil injection operations are avoided, and the reliability is higher.

### BRIEF DESCRIPTION OF THE DRAWINGS

Embodiments of the present disclosure and features and advantages thereof will be described in detail below with reference to the accompanying drawings. In the figures:

FIG. 1 is a schematic structural diagram of a microfluidic chip according to some embodiments of the present disclosure;

FIG. 2 is a front top view of a liquid injection housing according to some embodiments of the present disclosure;

FIG. 3 is a rear top view of a liquid injection housing according to some embodiments of the present disclosure;

FIG. 4 is a schematic structural diagram of a microfluidic chip substrate according to some embodiments of the present disclosure;

FIG. 5 is a schematic structural diagram of a liquid injection housing assembled with a conductive cover according to some embodiments of the present disclosure;

FIG. 6 is a schematic diagram of a gap sealant and adhesive bonding positions of a microfluidic chip according to some embodiments of the present disclosure;

FIG. 7 is a schematic structural diagram of a microfluidic chip according to some embodiments of the present disclosure;

FIG. 8 is a schematic structural diagram of a microfluidic chip according to some other embodiments of the present disclosure;

FIG. 9 is a front top view of a liquid injection housing according to some other embodiments of the present disclosure;

FIG. 10 is a rear top view of a liquid injection housing according to some other embodiments of the present disclosure;

FIG. 11 is a schematic structural diagram of a microfluidic chip substrate according to some other embodiments of the present disclosure;

FIG. 12 is a schematic structural diagram of a liquid injection housing assembled with a conductive cover according to some other embodiments of the present disclosure;

FIG. 13 is a schematic diagram of a gap sealant and adhesive bonding positions of a microfluidic chip according to some other embodiments of the present disclosure;

FIG. 14 is a schematic cross-sectional view of a microfluidic chip according to some embodiments of the present disclosure;

FIG. 15 is a schematic cross-sectional view of a microfluidic chip according to some other embodiments of the present disclosure;

FIGS. 16A and 16B are schematic flowcharts illustrating sample injection according to some embodiments of the present disclosure;

FIGS. 17A and 17B are schematic flowcharts illustrating liquid injection according to some embodiments of the present disclosure; and

FIGS. 18A, 18B, 18C, and 18D are schematic diagrams illustrating liquid injection and oil injection processes according to some embodiments of the present disclosure.

In the figures: 1—Microfluidic chip substrate; 2—Conductive cover; 3—Liquid injection housing; 4—Sample dosing plug; 5—Oil bubble cap; 6—Reagent bubble cap; 7—First vent; 8—Oil injection cavity; 9—Sample dosing cavity; 10—Liquid injection column; 11—Liquid injection cavity; 12—Oil intake conduit; 13—Liquid injection channel; 14—Liquid injection conduit; 15—Venting conduit; 16—Closed cavity; 17—Gap sealant; 18—Oil intake hole; 19—Liquid intake hole; 20—Sample intake hole; 21—Microelectrode array; 22—Hydrophobic layer; 23—Dielectric layer; 24, 40—Adhesive; 25—Second vent; 26—Third vent; 27—Fourth vent; 28—Fifth vent; 30—Oil outlet; 31—Piercing feature; 33—Oil inlet; 34—Venting column; 35—Sixth vent; 36—Seventh vent; 37—Eighth vent; 38—Notch feature.

In the figures, the same or similar elements are denoted by the same reference signs.

### DETAILED DESCRIPTION OF EMBODIMENTS

It should be understood that, in the description of the present disclosure, orientation or position relationships indicated by terms such as “center”, “longitudinal”, “transverse”, “up”, “down”, “front”, “rear”, “left”, “right”, “vertical”, “horizontal”, “top”, “bottom”, “inside”, and “outside” are based on orientation or position relationships shown in the accompanying drawings and are merely for ease of description of the present disclosure and simplification of the description, rather than indicating or implying that the apparatuses or elements referred to must have a specific orientation or be constructed and operated in a specific orientation, and therefore cannot be construed as limiting the present disclosure. In addition, the terms such as “first” and “second” are used for descriptive purposes only, and cannot be construed as indicating or implying relative importance or implicitly indicating the number of technical features indicated. Thus, the features defined with “first”, “second” and so on may explicitly or implicitly include one or more features. In the description of the present disclosure, “a plurality of” means two or more, unless otherwise specified.

It should be noted that in the description of the present disclosure, unless otherwise explicitly specified and defined, the terms “arranged”, “connected” and “connect” should be understood in a broad sense, for example, they may be a fixed connection, a detachable connection, or an integrated connection; may be a mechanical connection or an electrical connection; or may be a direct connection, an indirect connection by means of an intermediary, or internal communication between two elements. For those of ordinary skill in the art, the specific meanings of the terms mentioned above in the present disclosure should be construed according to specific circumstances.

Those skilled in the art should understand that the present disclosure inevitably includes necessary pipelines, conventional valves and general pump apparatuses for implementing a complete process. However, the above contents are not the main inventive points of the present disclosure. Those skilled in the art can add layouts by themselves based on a technological process and the structural form selection of the apparatus, on which the present disclosure does not have special requirements or specific limitations.

Digital microfluidic chips can integrate operation processes, such as sampling, dilution, reagent addition, reaction, separation, and detection, that are usually required in the biological, chemical, medical and other fields. Compared with conventional control means, this technology can allow for less sample consumption, also has the advantages of high sensitivity, high precision, high throughput, high integration and the like, can quickly implement the entire automatic integrated process of biochemical reactions with lower costs and allow the entire process reaction to be performed in fully enclosed environment and free of cross contaminations, and can be operated with one button, thereby greatly freeing an operator's hands.

According to a first aspect of the embodiments of the present disclosure, a microfluidic chip is provided. The technical solution of the present disclosure will be further described below with respect to specific implementations and with reference to the drawings.

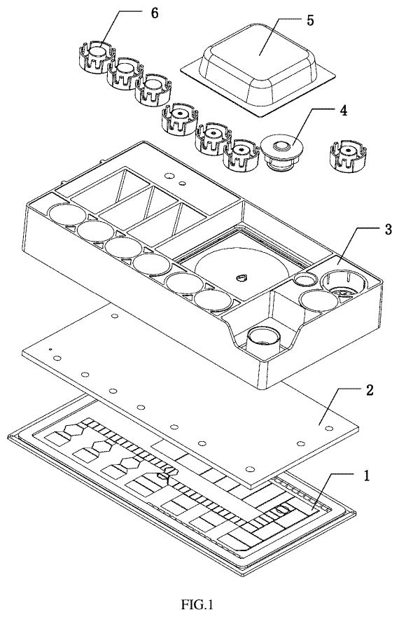

FIG. 1 shows a schematic structural diagram of a microfluidic chip according to some embodiments of the present disclosure. As shown in FIG. 1, the microfluidic chip comprises a microfluidic chip substrate 1, a conductive cover 2 and a liquid injection housing 3, which are sequentially stacked from bottom to top. As shown in FIG. 7, the microfluidic chip substrate 1 comprises, for example, a base plate. A microelectrode array 21 is arranged on the base plate, and a dielectric layer 23 and a hydrophobic layer 22 are sequentially stacked on the microelectrode array 21.

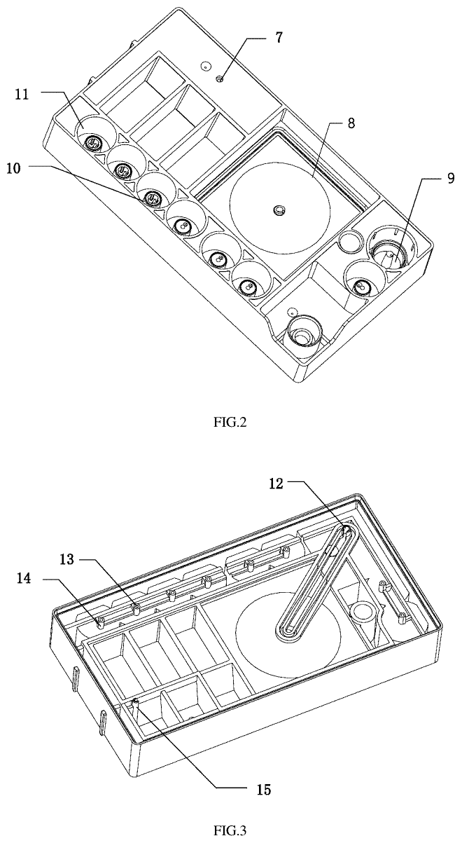

FIGS. 2 and 3 respectively show front and rear top views of the liquid injection housing according to some embodiments of the present disclosure. The liquid injection housing 3 comprises an oil injection cavity 8, a sample dosing cavity 9, and at least one side-by-side arranged liquid injection cavity 11, for example, six liquid injection cavities 11 uniformly arranged on one side of the liquid injection housing 3, as shown in FIG. 2. The oil injection cavity 8 is configured to arrange an oil bubble cap 5, that is, serving as a placement position for the oil bubble cap (such as a silicone oil bubble cap); the sample dosing cavity 9 is configured to arrange a sample dosing plug 4; and at least one liquid injection cavity 11 is configured to arrange at least one reagent bubble cap 6. The liquid injection housing 3 is provided with at least one liquid injection conduit 14 and an oil intake conduit 12. As shown in FIG. 3, the at least one liquid injection conduit 14 and the oil intake conduit 12 are provided on a back side of the liquid injection housing 3, that is, on a side facing away from the oil injection cavity 8 and the at least one liquid injection cavity 11. A liquid injection column 10, which is connected to a corresponding one of the at least one liquid injection conduit 14, is arranged in each of the at least one liquid injection cavity 11, and each of the at least one liquid injection conduit 14 forms a liquid injection channel 13, and the liquid injection conduits 14 collectively form a main liquid injection channel. An annular pit feature is provided in the oil injection cavity 8. As shown in FIG. 2, a raised oil injection column is arranged in the annular pit feature, and is in communication with the oil intake conduit 12. Surfaces of the oil injection cavity 8 and each liquid injection cavity 11 are each provided with a spike component such that the oil bubble cap or the reagent bubble cap is pierced when the oil bubble cap or the reagent bubble cap is pressed down.

Exemplarily, as shown in FIG. 1, the oil injection cavity 8, the sample dosing cavity 9 and the liquid injection cavity 11 of the liquid injection housing 3 may be used to arrange the oil bubble cap 5, the sample dosing plug 4 and the reagent bubble cap 6, respectively. The reagent bubble cap 6 and the oil bubble cap 5 are both provided with films (such as aluminum foils) to encapsulate a reagent and an oil (such as silicone oil).

According to some embodiments of the present disclosure, a microfluidic chip may be provided. The microfluidic chip has a structure for arranging the oil bubble cap and the reagent bubble cap, spike components for piercing the oil bubble cap and the reagent bubble cap, and hole structures for guiding the oil and the reagent into the corresponding channels. By pre-embedding the oil bubble cap and the reagent bubble cap in advance, the liquid injection operation can be performed automatically, and a fully automated application of the microfluidic chip can be implemented. Therefore, the operator does not need to manually inject the required reagent, sample and oil in sequence, the operator's hands are freed, and the microfluidic chip has high reliability, is portable while having high injection efficiency, and is suitable for popularization.

The microfluidic chip provided by the present disclosure is mainly used as a digital microfluidic chip, the reagent and other substances (such as a related liquid, solid, or solid-liquid mixture) required for detection may be quantitatively sealed in a reagent kit in advance, and the reagent kit is pre-embedded in a hole injection device in advance, which is sealed together with the digital microfluidic chip, so that a user does not need a manual operation during sample injection, and inconvenience, failure, waste and so on caused by manual operation errors can be prevented effectively.

In some embodiments, at least one venting conduit 15 is further arranged on the liquid injection housing 3. The liquid injection housing 3 is provided with at least one vent, each being connected to a respective venting conduit, and the venting conduit is led to a closed cavity for liquid flow in the microfluidic chip. By arranging the vent, when a liquid (such as a reagent, an oil or a sample) is injected into the closed cavity of the microfluidic chip, an excessive gas in the closed cavity can be discharged, facilitating the flow of the liquid. In some other embodiments, a plurality of vents may be connected to one venting conduit.

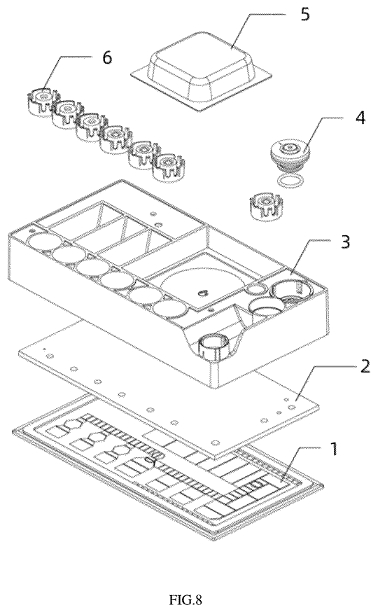

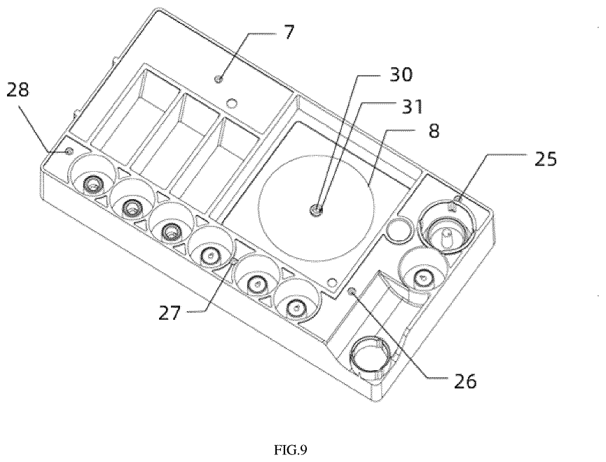

In some examples, for example, as shown in FIG. 2, at least one first vent 7 is formed nearby the oil injection cavity 8 in the liquid injection housing 3, and the first vent 7 is in communication with a first venting conduit 15. In some other examples, for example, as shown in FIGS. 8 and 9, in addition to the first vent 7, the liquid injection housing 3 is further provided with a second vent 25 located nearby the sample dosing cavity 9, a third vent 26 located between the sample dosing cavity 9 and the liquid injection cavity 11, a fourth vent 27 located between adjacent liquid injection cavities 11, and a fifth vent 28 located between the liquid injection cavity 11 and an edge of the liquid injection housing 3. Similar to the first vent 7, the second vent 25, the third vent 26, the fourth vent 27 and the fifth vent 28 may each be in communication with a venting conduit. For example, as shown in FIG. 10, the third vent 26 is in communication with a third venting column 34.

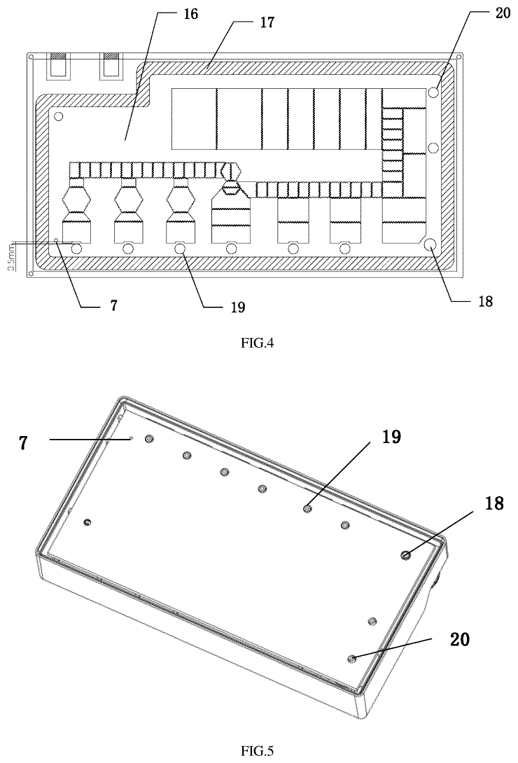

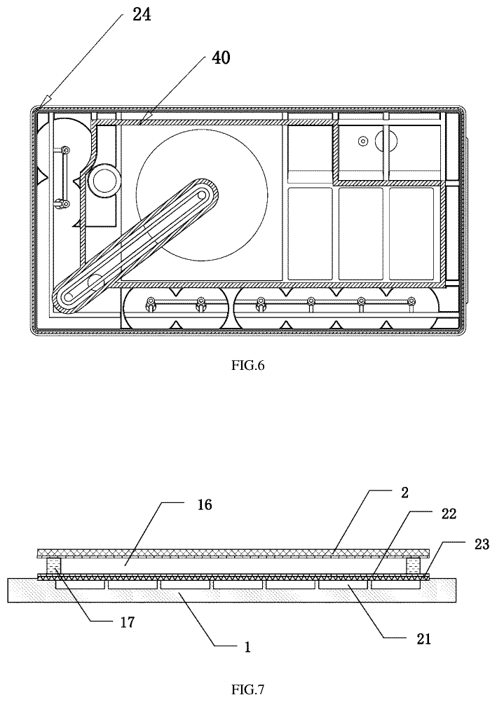

The microfluidic chip substrate 1, the conductive cover 2 and the liquid injection housing 3, which are sequentially stacked from bottom to top, are assembled to form the microfluidic chip. For example, the microfluidic chip substrate 1, the conductive cover 2 and the liquid injection housing 3 may be bonded to each other. In some embodiments, for example, as shown in FIG. 4, the microfluidic chip substrate 1 and the conductive cover 2 are connected to each other by using a gap sealant 17. The gap sealant 17 is circumferentially arranged between the microfluidic chip substrate 1 and the conductive cover 2, and a closed cavity 16 is formed by the microfluidic chip substrate 1, the conductive cover 2 and the gap sealant 17. The conductive cover 2 is bonded to the liquid injection housing 3 by means of an adhesive 40, and an edge of the liquid injection housing 3 is bonded to an edge of the microfluidic chip substrate 1 by means of an adhesive 24 to form a seal. FIG. 6 illustratively shows the position of the adhesive 40 for bonding the conductive cover to the liquid injection housing, and the position of the adhesive 24 for bonding the liquid injection housing to the microfluidic chip substrate, on the liquid injection housing 3 in the microfluidic chip.

In some embodiments, the conductive cover 2 is a transparent conductive cover. For example, the conductive cover 2 is made of glass, such as ITO glass.

In some embodiments, the conductive cover 2 is provided with at least one through hole. The through holes are in communication with the closed cavity 16, and comprise a liquid intake hole 19, a sample intake hole 20 and an oil intake hole 18. The liquid intake hole 19 and the oil intake hole 18 are aligned with the liquid injection conduit 14 and the oil intake conduit 12, respectively. In some other embodiments, the through holes in the conductive cover 2 further comprise at least one vent, which is respectively aligned with a corresponding venting conduit 15 arranged on the liquid injection housing 3.

For example, the liquid injection conduit 14 may extend out of the liquid intake hole 19 by a certain distance. The distance by which the liquid injection conduit extends out of the liquid intake hole is, for example, 0.3-0.5 mm or, for example, 0.55-0.7 mm. This distance may be, for example, 0.3 mm, 0.33 mm, 0.35 mm, 0.4 mm, 0.43 mm, or 0.5 mm, but is not limited to the listed values. Other values within this value range that are not listed are also applicable. Similarly, the oil intake conduit 12 and the venting conduit 15 may also extend out of the oil intake hole 18 and the vent 7 by a certain distance.

The through hole may be arranged at a distance of 0.5-1 mm from the edge of the conductive cover. It should be noted that the distance from the edge here serves as a safe distance, for example, it may be 0.5 mm, 0.6 mm, 0.7 mm, 0.8 mm, 0.9 mm, or 1 mm, but not limited to the listed values. Other values within this value range that are not listed are also applicable. In addition, the arrangement of the liquid intake hole 19 and the sample intake hole 20 among the through holes is related to the position of an electrode on the microfluidic chip substrate 1, and projections of the edges of the through holes on the microfluidic chip substrate are spaced apart from the electrode on the microfluidic chip substrate by a safe distance of at least 0.5 mm, for example. The oil intake hole 18 needs to be formed in an area of the conductive cover corresponding to an electrodeless area of the microfluidic chip substrate 1, that is, a projection of the oil intake hole 18 on the microfluidic chip substrate does not coincide with the electrode on the microfluidic chip substrate 1.

It should be noted that the embodiments of the present disclosure do not have specific requirements or special limitations on structural features of the through holes, such as the size, shape and material. The through holes are used for providing inlets for the injection of the sample, the reagent, and the oil. Therefore, it can be understood that other structures enabling such functions can be used in the embodiments of the present disclosure, and those skilled in the art can make adaptive adjustments on the size, the shape, and the material of the through holes according to usage scenarios and test conditions.

In some embodiments, the liquid injection conduit 14 in the liquid injection housing 3 extends out of a lower surface of the transparent conductive cover by a distance of 0.55-0.7 mm, for example. The liquid injection channel 13 comprises a liquid intake end and a liquid discharge end. The liquid discharge end is provided with a notch configured to guide a flow. The liquid injection channel 13 has an inclination. Further, the inclination of the liquid injection channel 13 is between 5°-10°, for example, it may be 5°, 6°, 7°, 8°, 9°, or 10°, but not limited to the listed values. Other values within this value range that are not listed are also applicable.

In some embodiments, the liquid injection channel 13 typically has an inclination toward the electrode, the liquid injection channel 13 may be a straight hole, an inclined hole, a spiral hole, a tubular fitting assembled to the liquid injection column 10, etc., and the shape of the channel is not limited to a circular shape, as long as an upper part of the liquid injection column 10 is in communication with a gap cavity of the chip. Those skilled in the art can make a choice according to actual situations. The inclined hole of the liquid injection channel is designed to be fitted with the through hole in the transparent conductive cover, so that the successful and stable injection of the liquid is ensured.

The microfluidic chip according to the embodiments of the present disclosure can inject a plurality of liquid reagents or samples simultaneously, has higher efficiency, good expansibility, and convenience, and provides the basic feasibility for the full automation of the digital microfluidic chip, so that the operator does not need to manually inject the required reagents, samples and oil in sequence, and the operator's hands are freed.

FIGS. 8 to 13 show a microfluidic chip according to some other embodiments of the present disclosure. In FIGS. 8 to 13, elements having the same reference numerals as those in FIGS. 1 to 7 denote the same or similar elements.

As shown in FIGS. 8 and 9, the bottom of the oil injection cavity 8 for arranging the oil bubble cap is provided with a groove, and an oil outlet 30 is arranged in the center of the groove. A spike component is arranged around the oil outlet 30, such as a piercing feature 31 with a protruding portion, and the oil bubble cap 5 is placed at an oil bubble cap placement position such that the oil bubble cap matches the oil injection cavity 8. When the oil bubble cap 5 is pressed down, the piercing feature 31 pierces the film (e.g., the aluminum foil) of the oil bubble cap 5, and the oil flows from the oil outlet 30 to the closed cavity 16 of the microfluidic chip through the oil injection channel and an oil inlet 33 (as shown in FIG. 10).

As mentioned above, as shown in FIGS. 8 and 9, in addition to the first vent 7, the liquid injection housing 3 is further provided with the second vent 25, the third vent 26, the fourth vent 27 and the fifth vent 28. The second vent 25, the third vent 26, the fourth vent 27 and the fifth vent 28 may each be in communication with a venting conduit. For example, as shown in FIG. 10, the third vent 26 is in communication with a third venting column 34.

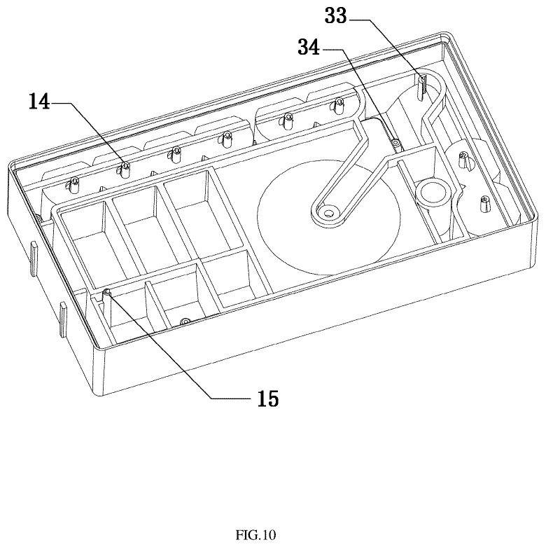

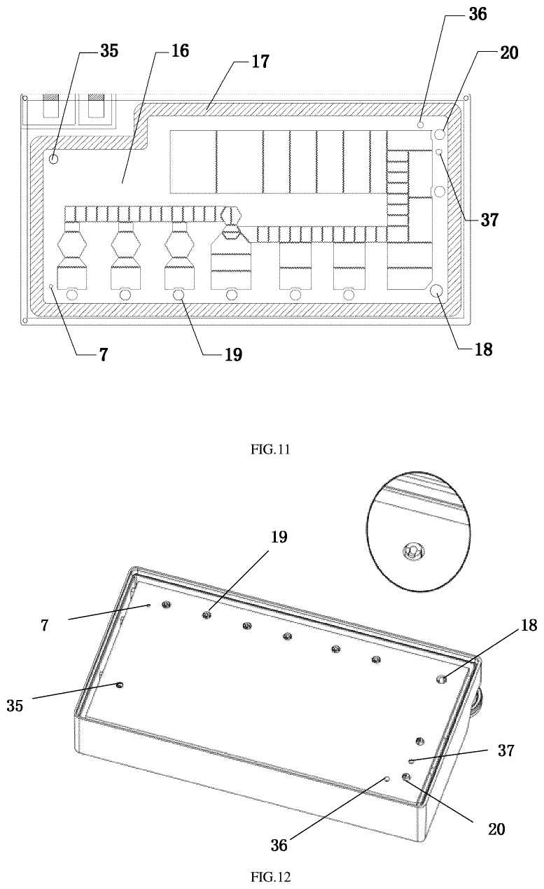

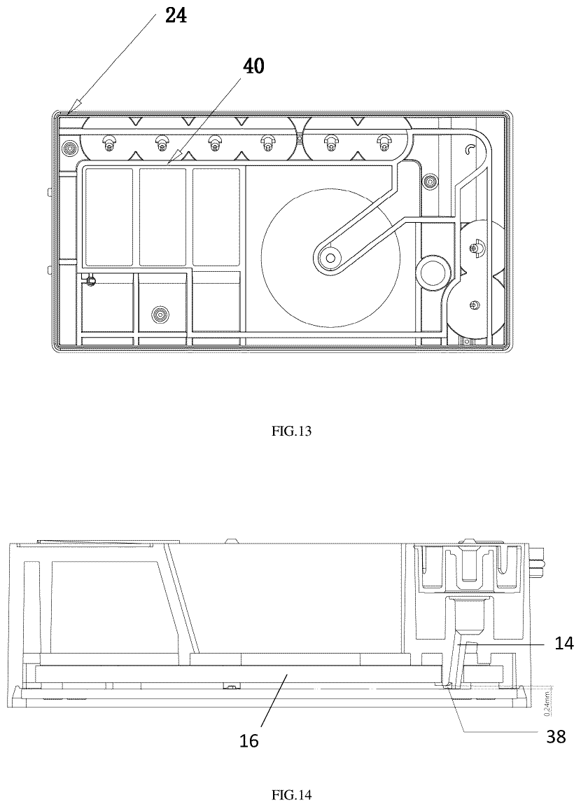

As shown in FIGS. 11 and 12, the conductive cover 2 is further provided with a plurality of vents 35-37. The sixth vent 35 is typically arranged in an area diagonally opposite to the oil intake hole 18, there is no electrode in the corresponding area of the microfluidic chip substrate 1, and the seventh vent 36 and the eighth vent 37 are typically arranged nearby the sample intake hole 20. During sample injection, gas is discharged outwardly from the seventh vent 36 and the eighth vent 37 to maintain an air pressure in the closed cavity 16, so that bubbles are prevented from entering the closed cavity 16.

In some embodiments, as shown in FIG. 14, after the microfluidic chip is assembled, the liquid injection conduit 14 is provided with a notch feature 38 toward the closed cavity 16 to facilitate the flow of the liquid into the closed cavity, and the depth of the notch may be, for example, 0.24 mm.

According to a second aspect of the embodiments of the present disclosure, a liquid injection method for a microfluidic chip is provided.

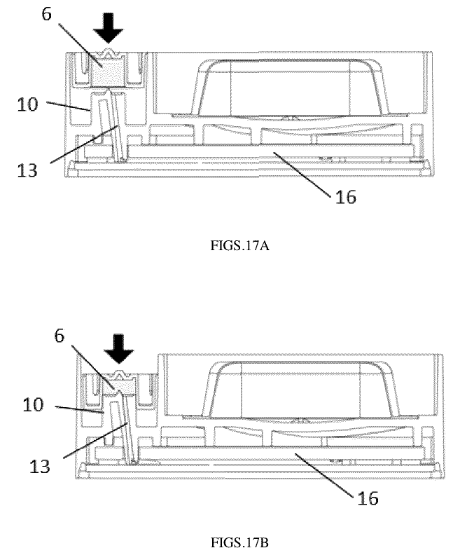

As shown in FIGS. 17A and 17B, during liquid injection, the reagent bubble cap 6 is pressed down, the liquid injection column 10 continuously enters the reagent bubble cap 6, a liquid (e.g., a reagent) in the reagent bubble cap 6 is pressed, the reagent bubble cap 6 forms a seal with the liquid injection column 10 in the downward pressing process and is pierced by a corresponding spike component, the liquid in the reagent bubble cap flows into the closed cavity 16 of the microfluidic chip through the liquid injection channel 13, and a voltage of the microelectrode array 21 is regulated, such that the liquid flowing from the reagent bubble cap to the closed cavity 16 reaches the designated position.

During oil injection, the oil bubble cap 5 is pressed down, the oil injection column continuously enters the oil bubble cap 5, a liquid (e.g., oil) in the oil bubble cap 5 is pressed, the oil bubble cap 5 forms a seal with the oil injection column in the downward pressing process (for example, to cause the oil to flow to a lower side of the liquid injection housing only by means of the oil injection column, so as to prevent the oil from being leaked into the oil injection cavity 8 for placing the oil bubble cap) and is pierced by a corresponding spike component, the liquid in the oil bubble cap flows into the closed cavity 16 of the microfluidic chip through the oil intake hole 18, and the voltage of the microelectrode array 21 is regulated, such that the liquid flowing from the oil bubble cap to the closed cavity 16 reaches a designated position.

Alternatively, during oil injection, the oil bubble cap 5 is pressed down, the oil bubble cap 5 is pierced by the spike component in the downward pressing process, and a liquid (e.g., oil) in the oil bubble cap 5 flows into the closed cavity 16 of the microfluidic chip through the oil intake hole 18. There is no need to regulate the voltage of the microelectrode array 21.

In some embodiments, the liquid injection method comprises:
pressing down the oil bubble cap at a first speed such that the liquid in the oil bubble cap enters the closed cavity and occupies part of the bottom surface area of the closed cavity;
pressing down the reagent bubble cap to cause the liquid in the reagent bubble cap to enter the closed cavity; and
pressing down the oil bubble cap at a second speed such that the liquid in the oil bubble cap occupies the entire bottom surface area of the closed cavity, wherein the second speed is less than the first speed.

In some embodiments, the liquid injection method further comprises:
after pressing down the oil bubble cap at the first speed, stopping pressing down the oil bubble cap, and lifting the oil bubble cap upwardly by a distance of 2 mm, for example.

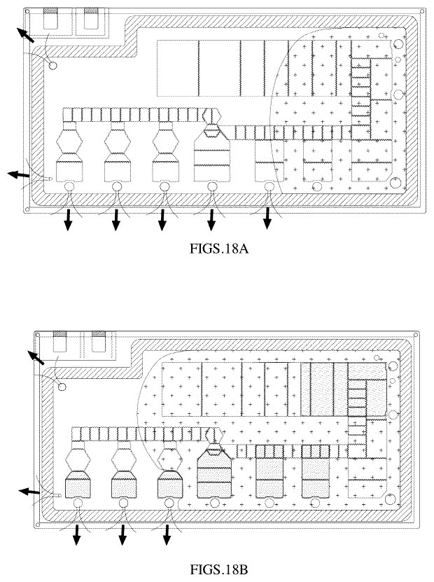

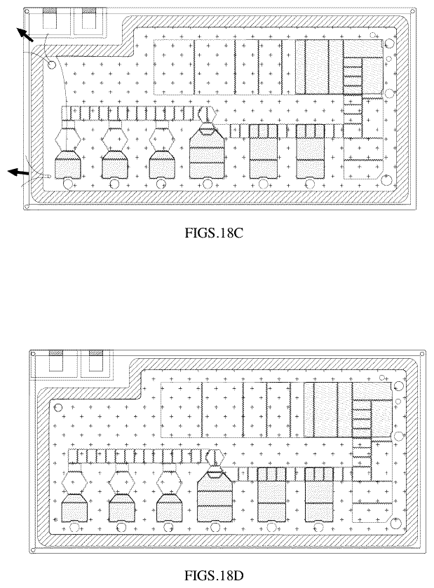

For example, as shown in FIGS. 18A-18D, in the oil injection process, the oil bubble cap is pressed down to cause the oil to enter the closed cavity from the oil intake hole. When the oil flowing into the closed cavity occupies approximately half of the bottom surface area of the closed cavity, as shown in FIG. 18A, pressing down the oil bubble cap is stopped, and the oil bubble cap is lifted upwardly by a distance of 2 mm, for example. In this case, the liquid (reagent) injection operation begins, and the liquid enters the closed cavity through the liquid injection conduit; after the liquid injection operation is completed, the oil bubble cap continues to be pressed down, the downward pressing speed of the oil bubble cap at this time becomes lower than the downward pressing speed before the liquid injection, to continuously discharge air in the closed cavity from the vents (e.g., the sixth vent, the seventh vent and the eighth vent), and finally the closed cavity 16 is filled, as shown in FIGS. 18B-18D.

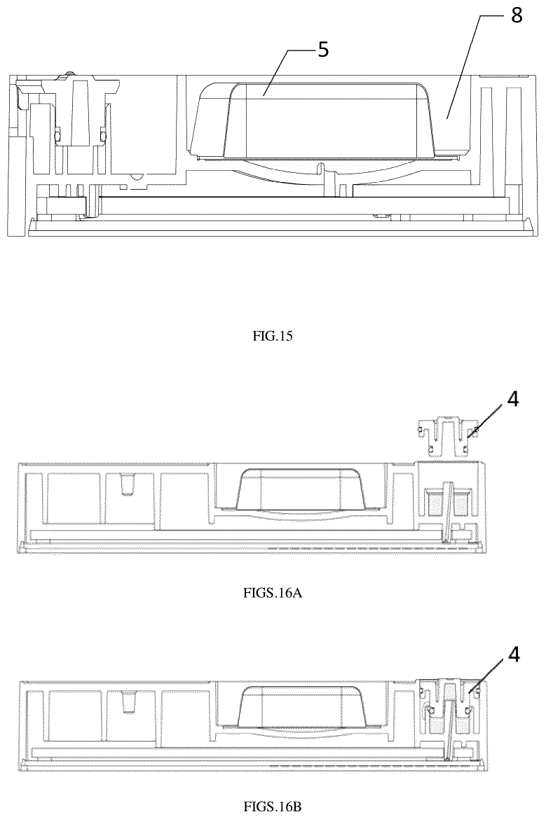

In some embodiments, as shown in FIGS. 16A-16B, a sample injection method is provided. By pressing down the sample dosing plug, a sample flows into the closed cavity through a channel in the sample injection column.

According to a third aspect of the embodiments of the present disclosure, a use of the microfluidic chip described in the first aspect is provided. The microfluidic chip is used in the field of digital microfluidic chips.

In the embodiments of the present disclosure, by pre-embedding the reagent and cooperating with a hole injection device, the liquid injection operation can be performed automatically, and the fully automated application of the microfluidic chip can be implemented. Therefore, the operator does not need to manually inject the required reagent, sample and oil in sequence, the operator's hands are freed, and the microfluidic chip has high reliability, is portable while having high injection efficiency, and is suitable for popularization.

The applicant gives notice that the foregoing descriptions are only specific implementations of the present disclosure, but the scope of protection of the present disclosure is not intended thereto. Those skilled in the pertinent technical field shall understand that any variations or replacements that can be easily conceived by a person skilled in the art within the technical scope disclosed in the present disclosure shall fall within the scope of protection of the present disclosure.

1. A microfluidic chip, wherein the microfluidic chip comprises a microfluidic chip substrate, a conductive cover and a liquid injection housing, which are sequentially stacked from bottom to top, wherein the liquid injection housing is provided with at least one liquid injection conduit and an oil intake conduit;
wherein the liquid injection housing comprises an oil injection cavity, a sample dosing cavity, and at least one side-by-side arranged liquid injection cavity, wherein the oil injection cavity, the sample dosing cavity and the at least one liquid injection cavity are used to arrange an oil bubble cap, a sample dosing plug and at least one reagent bubble cap, respectively;
a liquid injection column connected to a corresponding one of the at least one liquid injection conduit is arranged respectively in each of the at least one liquid injection cavity, and each of the at least one liquid injection conduit forms a liquid injection channel;
an oil injection column is arranged in the oil injection cavity and is connected to the oil intake conduit;
and surfaces of the oil injection cavity and the at least one liquid injection cavity are each correspondingly provided with a spike component.

2. The microfluidic chip according to claim 1, wherein at least one venting conduit is arranged on the liquid injection housing, the liquid injection housing is provided with at least one vent, and the at least one vent is each in communication with one of the at least one venting conduit.

3. The microfluidic chip according to claim 1, wherein the microfluidic chip substrate and the conductive cover are connected to each other by using a gap sealant circumferentially arranged between the microfluidic chip substrate and the conductive cover, and a closed cavity is formed by the microfluidic chip substrate, the conductive cover and the gap sealant.

4. The microfluidic chip according to claim 3, wherein the conductive cover is provided with at least one through hole, the at least one through hole is in communication with the inside of the closed cavity, the at least one through hole comprises at least one liquid intake hole, a sample intake hole and an oil intake hole, and the at least one liquid intake hole and the oil intake hole are aligned with the at least one liquid injection conduit and the oil intake conduit, respectively.

5. The microfluidic chip according to claim 3, wherein the conductive cover is provided with at least one through hole, the at least one through hole is in communication with the inside of the closed cavity, the at least one through hole comprises a vent, and the vent is aligned with a corresponding venting conduit arranged on the liquid injection housing.

6. The microfluidic chip according to claim 4, wherein the at least one through hole is arranged at a distance of 0.5-1 mm from an edge of the conductive cover.

7. The microfluidic chip according to claim 4, wherein a projection of an edge of the at least one through hole on the microfluidic chip substrate is spaced apart from an electrode on the microfluidic chip substrate by a distance of at least 0.5 mm, and the oil intake hole of the at least one through hole is formed in an area of the conductive cover corresponding to an electrodeless area of the microfluidic chip substrate.

8. The microfluidic chip according to claim 1, wherein the conductive cover is a transparent conductive cover.

9. The microfluidic chip according to claim 1, wherein the conductive cover is bonded to the liquid injection housing by means of an adhesive, and an edge of the liquid injection housing is bonded to an edge of the microfluidic chip substrate by means of an adhesive to form a seal.

10. The microfluidic chip according to claim 1, wherein the microfluidic chip substrate comprises a base plate, a microelectrode array is arranged on the base plate, and a dielectric layer and a hydrophobic layer are sequentially stacked on the microelectrode array.

11. The microfluidic chip according to claim 1, wherein the at least one liquid injection conduit each extends out of a corresponding through hole formed in the conductive cover.

12. A liquid injection method for a microfluidic chip according to claim 1, the liquid injection method comprising:
during liquid injection, the liquid injection column continuously entering a corresponding reagent bubble cap to press a liquid in the reagent bubble cap, the reagent bubble cap forming a seal with the liquid injection column in the downward pressing process, piercing the reagent bubble cap by the respective spike component, the liquid in the reagent bubble cap flowing into the closed cavity of the microfluidic chip through the liquid injection channel, and regulating a voltage of the microelectrode array arranged on the base plate of the microfluidic chip substrate, such that the liquid flowing from the reagent bubble cap to the closed cavity reaches a designated position; and
during oil injection, the oil injection column continuously entering the oil bubble cap to press a liquid in the oil bubble cap, the oil bubble cap forming a seal with the oil injection column in the downward pressing process, piercing the oil bubble cap by the respective spike component, the liquid in the oil bubble cap flowing into the closed cavity of the microfluidic chip through the oil intake hole, and regulating the voltage of the microelectrode array arranged on the base plate of the microfluidic chip substrate, such that the oil liquid flowing from the oil bubble cap to the closed cavity reaches a designated position.

13. The liquid injection method according to claim 12, further comprising:
pressing down the oil bubble cap at a first speed such that the liquid in the oil bubble cap enters the closed cavity and occupies part of the bottom surface area of the closed cavity;
pressing down the reagent bubble cap to cause the liquid in the reagent bubble cap to enter the closed cavity; and
pressing down the oil bubble cap at a second speed such that the liquid in the oil bubble cap occupies the entire bottom surface area of the closed cavity, wherein the second speed is less than the first speed.

14. The liquid injection method according to claim 13, further comprising:
after pressing down the oil bubble cap at the first speed, stopping pressing down the oil bubble cap, and lifting the oil bubble cap upwardly by a distance.

15. An oil injection method for a microfluidic chip according to claim 1, the oil injection method comprising:
during liquid injection, the liquid injection column continuously entering a corresponding reagent bubble cap to press a liquid in the reagent bubble cap, the reagent bubble cap forming a seal with the liquid injection column in the downward pressing process, piercing the reagent bubble cap by the respective spike component, the liquid in the reagent bubble cap flowing into the closed cavity of the microfluidic chip through the liquid injection channel, and regulating a voltage of the microelectrode array arranged on the base plate of the microfluidic chip substrate, such that the liquid flowing from the reagent bubble cap to the closed cavity reaches a designated position; and
during oil injection, piercing the oil bubble cap by the respective spike component in the downward pressing process, and the liquid in the oil bubble cap flowing into the closed cavity of the microfluidic chip through the oil intake hole.

16. The use of a microfluidic chip according to claim 1, the microfluidic chip being used in the field of digital microfluidic chips.

17. The microfluidic chip according to claim 8, wherein the conductive cover is made of glass.

18. The microfluidic chip according to claim 11, wherein:
a distance by which each of the at least one liquid injection conduit extends out of a corresponding through hole is between 0.55-0.7 mm;
the liquid injection channel comprises a liquid intake end and a liquid discharge end, the liquid discharge end being provided with a notch configured to guide a flow;
the liquid injection channel has an inclination;
the inclination of the liquid injection channel is between 5°-10°; and/or
an aluminum foil is provided in each of the at least one reagent bubble cap and the oil bubble cap.
